(19) United States
(12) Patent Application Publication
(10) Pub. No.: US 2003/0220116 A1
(43) Pub. Date: Nov. 27, 2003

(54) Method and apparatus for determining the position of a portable device

(75) Inventors: Willy Sagefalk, Veberod (SE); Mikael Pahmp, Ramlosa (SE)

Correspondence Address: IP CREATORS, P. O. BOX 2789, CUPERTINO, CA, 95015, US

(73) Assignee: AXIS AB, LUND (SE)

(21) Appl. No.: 10/421,550

(22) Filed: Apr. 22, 2003

Related U.S. Application Data
(60) Provisional application No. 60/394,559, filed on Jul. 8, 2002.

(30) Foreign Application Priority Data
Apr. 23, 2002 (SE) 0201203-7

(51) Int. Cl. H04Q 7/20

(52) U.S. Cl. 455/456.1; 455/440

(57) ABSTRACT

Method and Apparatus are disclosed for determining the position of a portable device in a wireless network formed by a plurality of base stations. In an embodiment an apparatus for determining a location of a wireless device in a wireless communication network provided by a plurality of base stations is disclosed. The apparatus comprises a signal strength table and a positioning service module. The signal strength table characterizes signal strengths relative to each of plurality base stations at each of a plurality of locations in the wireless communication network. The positioning service module correlates an actual received signal strength for a communication with the wireless device with at least one of the received signal strengths in the signal strength table, to determine the position of the wireless device. Alternate means and methods are also disclosed for determining the position of the portable device.

### CROSS REFERENCE TO RELATED APPLICATION

This application claims the benefit of priority to Swedish Application No. 0201203-7, filed on Apr. 23, 2002, entitled “Method and Apparatus for Determining the Position of A Portable Device” and prior filed co-pending Provisional Applications No. 60/394,559, filed on Jul. 8, 2002 entitled “Method and Apparatus for Determining the Position of A Portable Device” (Atty. Docket # AWAPP006P) which are incorporated herein by reference in their entirety as if fully set forth herein.

### TECHNICAL FIELD OF THE INVENTION

The present invention relates to a method and a portable device for determining the position of said device, wherein said device has short range wireless communication capability. The invention further relates to a method in a system comprising base stations for determining the position of a portable device having short range wireless communication capability.

### BACKGROUND OF THE INVENTION

Satellite based positioning systems, in particular the Global Position System (GPS) and also the Russian system GLOSNASS, are increasingly used for determining the position of vehicles, cellular phones and other mobile devices. The communication between a mobile device and satellites is dependent on a free line of sight and is therefore blocked at places such as inside buildings or tunnels. However, methods have been developed the last few years to use a short range wireless communication system, like Bluetooth, to supplement or replace the satellite based positioning system at places where the satellites are blocked.

In WO 01/58098 A2 there is described an apparatus and a method to determine the position of a wireless device, where Bluetooth communication is used in combination with GPS. The method relies on transferring positioning information from a device which knows its position, because it is in fixed position or because it has a GPS receiver or other means for determining its own position, to another device using Bluetooth technology.

According to one aspect of this method, a first Bluetooth device may retrieve position information from a second Bluetooth device within Bluetooth range and approximate its own position with the position of the second Bluetooth device. This is a simple method for positioning but its accuracy is restricted to telling that the first Bluetooth device is positioned within the transmission range of the second Bluetooth device.

According to another aspect of the method described in WO 01/58098 A2, a first Bluetooth device may retrieve position information from several other Bluetooth devices within Bluetooth range in order to achieve additional positioning accuracy. However, this method of positioning is slow.

WO 01/50151 A1 describes a method for localizing a moving object using a satellite based positioning system such as GPS and a short range wireless system such as a system that conforms to the Bluetooth specifications.

According to one aspect of this method, a Bluetooth base station transmits its location to a cellular phone. This location information is then used either in addition to the results of GPS calculations or in replacement of them to determine the position of the cellular phone. This method is very similar to the first aspect of the method according to WO 01/58098 A2, and is thus a simple but less accurate method for positioning.

According to an alternative aspect of the method described in WO 01/50151 A1, a base station is allocated a unique identification number and the location of the base station is recorded in a lookup table. When queried, the base station transmits its identification number to a cellular phone via a return signal. The lookup table is then used to determine the location of the base station, and hence the cellular phone, corresponding to the received identification number. According to WO 01/50151 A1, this method eliminates the need for pre-programming of location of the base station. However, the positioning accuracy is still limited to the transmission range of the base station.

### SUMMARY OF THE INVENTION

An object of the present invention is to provide an improved method, portable device and system for determining the position of the portable device in a wireless network formed by a plurality of base stations.

In an embodiment an apparatus for determining a location of a wireless device in a wireless communication network provided by a plurality of base stations is disclosed. The apparatus comprises a signal strength table and a positioning service module. The signal strength table characterizes signal strengths relative to each of plurality base stations at each of a plurality of locations in the wireless communication network. The positioning service module correlates an actual received signal strength for a communication with the wireless device with at least one of the received signal strengths in the signal strength table, to determine the position of the wireless device.

In an embodiment of the invention a method for determining a location of a wireless device in a wireless communication network provided by a plurality of base stations is disclosed. The method comprises the acts of:

characterizing signal strengths relative to each of the base stations at each of a plurality of locations in the wireless communication network; and

correlating an actual received signal strength for a communication with the wireless device with at least one of the signal strengths characterized in the characterizing act, whereby to determine the position of the wireless device.

In an alternate embodiment of the invention a method in a portable device for determining a position of the portable device in a wireless communication network provided by a plurality of base stations is disclosed. The method comprises the acts of

acquiring an identity of at least one of the plurality of base stations within a transmission range of the portable device;

retrieving a list comprising information about which of the plurality of base stations cover specific position segments in the wireless communication network formed by the plurality of base stations; and

determining the position of the portable device from the information in the list and the acquired identity.

In still another embodiment of the invention a portable device operable in a wireless communication network provided by a plurality of base stations is disclosed. The portable device comprises:

means for acquiring an identity of at least one of the plurality of base stations within a transmission range of the portable device;

means for retrieving a list comprising information about which base stations cover specific position segments in the wireless communication network formed by the plurality of base stations; and

means for determining the position of the portable device from the information in the list and the acquired identity.

In another embodiment of the invention a method for determining a position of a portable device in a wireless communication network provided by a plurality of base stations is disclosed. The method comprises the acts of

transmitting an identity from corresponding ones of the plurality of base stations within a transmission range of the portable device to the portable device;

transmitting a list from one of the plurality of base stations to the portable device, and the list comprising information about which of the plurality of base stations cover specific position segments in the wireless communication network formed by the plurality of base stations; and

determining within the portable device, a position of the portable device from the information in the list and the transmitted identity.

### BRIEF DESCRIPTION OF THE DRAWINGS

The present invention will now be described in more detail with reference to the accompanying drawings, in which

FIG. 1 schematically illustrates an embodiment of a system for determining the position of a portable device.

FIG. 2 is a candlestick diagram showing a method for determining the position of a portable device (client) which communicates with a network which includes base stations and a server.

FIG. 3 is a candlestick diagram showing a method for determining the position of a portable device (client) which communicates with a network which includes base stations.

FIG. 4 schematically illustrates an embodiment of a system according to the invention in which the transmission ranges of three base stations are at substantially equal to one another.

FIG. 5 schematically illustrates an embodiment of a system according to the invention in which the transmission ranges of three base stations are irregular and different.

FIG. 6 is a data structure diagram of an embodiment of the position information for each base station.

FIGS. 7A-C are combined hardware and software block diagrams showing three different embodiments of the invention with varying position processing capabilities in one or more of the clients, base stations, and servers.

FIGS. 8A-E are process flow diagrams associated with position determination in the embodiments of the invention shown in FIGS. 7A-C.

### DETAILED DESCRIPTION OF PREFERRED EMBODIMENTS

A method and apparatus for determining the position of a wireless portable device operable in a communication network defined by a plurality of base stations is disclosed.

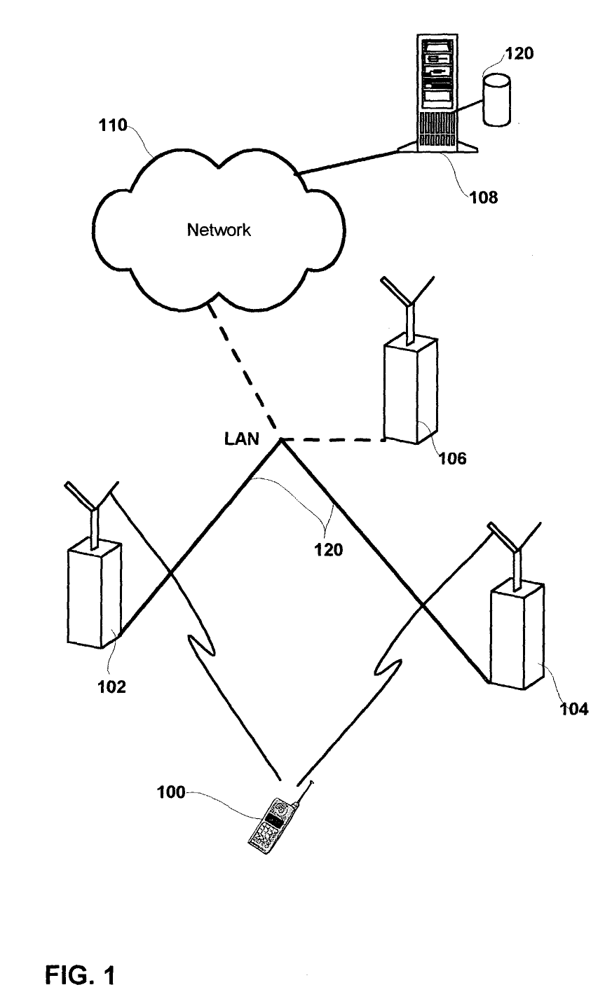

FIG. 1 shows an embodiment of a system according to the invention which comprises a portable device 100 in wireless communication with one or more of base stations 102, 104, 106. The base stations are connected to each other via a local area network (LAN) 120. The portable device 100 comprises short range wireless communication capability by which it is able to communicate with the base stations 102, 104 (and 106) and access the LAN.

In a specific embodiment, the system further comprises a server 108. The server is accessible from the LAN 120 either directly of via a wide area network (WAN), or the Internet 110. In an embodiment of the invention the server 108 stores information in memory 120 about the positions of the base stations in a list.

In an alternative embodiment, the information about the positions of the base stations 102, 104, 106 is stored in partial lists at each base station.

The list or the partial lists may be in the form of any information structure recordable in a data file which may be stored in a portable device, on a server, in a base station etc.

The portable device 100, which will be referred to as “client” (in a wireless network) in the rest of the description, may be a mobile phone, a PDA (Personal Digital Assistant), a Laptop, a luggage tag, etc. Actually, the client may be anything mobile that wishes to determine its location in the presence of a wireless local area network.

Each said base station 102, 104, 106 may be any stationary device which is able to provide wireless access to a local area network (LAN).

The communication between the client and the base stations may be provided by means of any specification for short range wireless communication, e.g. 802.11 or Bluetooth.

The LAN may be either wired or wireless but is permanent and stationary.

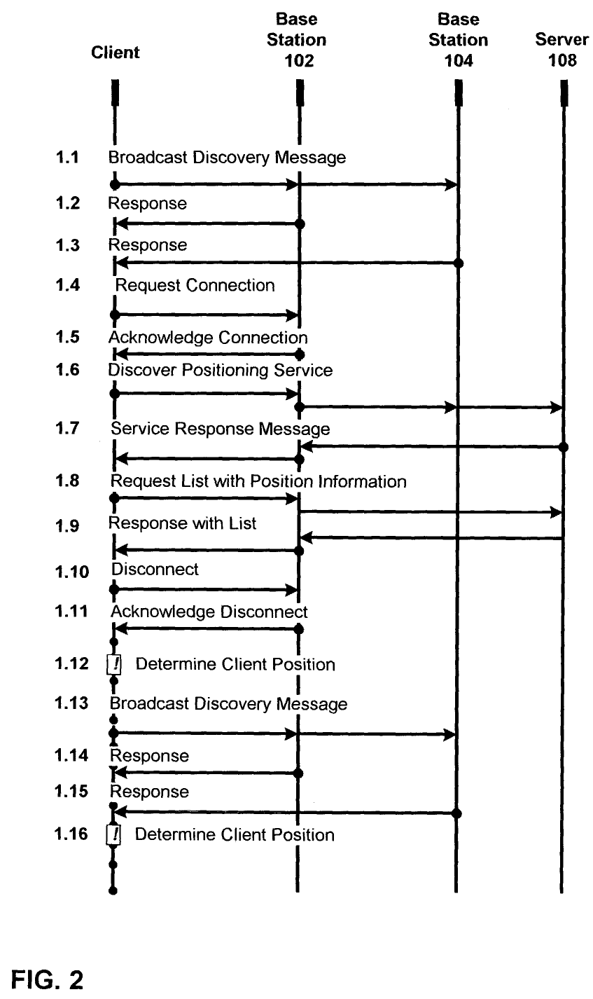

FIG. 2 is a candlestick diagram showing a method for determining the position of a portable device (client) which communicates with a network which includes base stations and a server. First, the client broadcasts a discovery message in the form of a packet in order to search (or scan) the “area” for base stations and acquire base station identities (step 1.1). This discovery message is received by each base station, in this case two base stations, which are within transmission range of the client. Each base station within transmission range then responds to the discovery message by broadcasting an announcement packet (steps 1.2 and 1.3), which includes the identity and type of base station device plus any information needed to connect to this type of base station.

Alternatively, the client may search the area and acquire base station identities by listening for announcement packets repeatedly broadcasted by the base stations (this is an alternative mode in 802.11).

When the client has received an announcement packet from at least one base station, it will be able to connect to that base station (base station 102) in order to get LAN access so that it may retrieve a list with position information. The client connects to base station 102 by requesting a connection to it (step 1.4), using the identity of base station 102 as destination address. Base station 102 then acknowledges the connection (step 1.5) whereby a link is established between the client and base station 102.

When a link has been established, the client may retrieve the list with position information by using a network discovery method to multicast a discovery message for a required positioning service (step 1.6). The server providing the requested positioning service then responds with a service response message (step 1.7).

An example of a network discovery method for TCP/IP networks is the Service Location Protocol (SLP). With SLP services are located by multicasting a “Service Request” message for a certain “Service Type”. All services matching the Service Type then responds with a “Service Response” message.

When the client has received the service response message from the server, the client requests for a list with position information from the server (step 1.8). The server, storing the list, then responds the client by transmitting the list to the client (step 1.9).

When the client has received the list with position information from the server, it disconnects with base station 102 (steps 1.10 and 1.11), and may now determine its own position by means of the acquired base station identities and the list with position information (step 1.12).

Once a list with position information is received, the client may go ahead updating the positioning by searching the area for new base stations (steps 1.13, 1.14 and 1.15), and again determine its own position (step 1.16).

If the list covers all base stations in e.g. a LAN within a specific area, the list must not necessarily be updated until the position of a base station in the LAN is changed or the client enters a new specific area.

As mentioned above, the list may in an alternative embodiment be stored as partial lists at each base station.

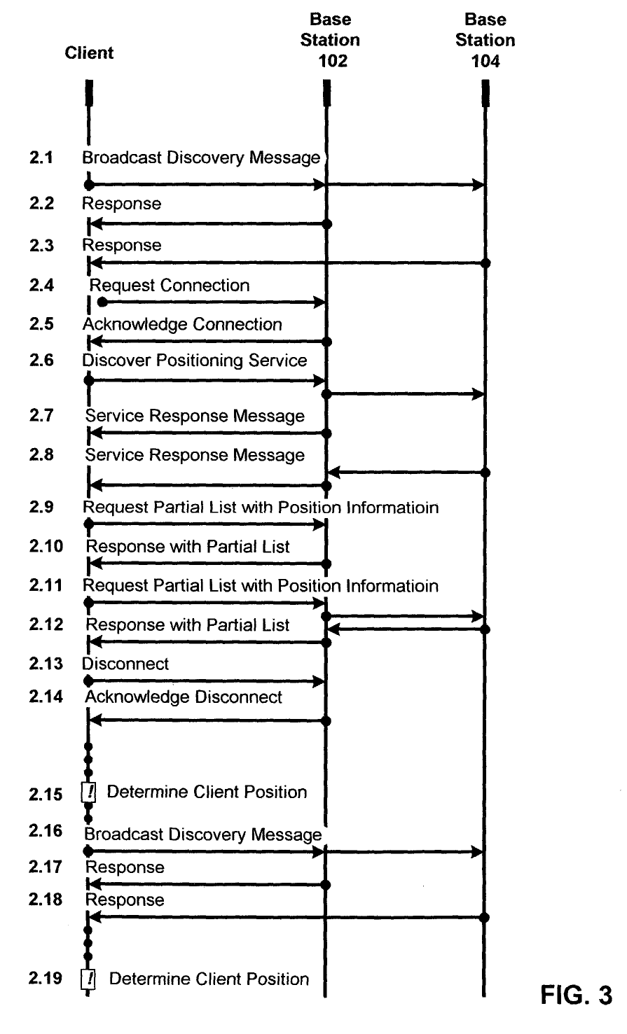

FIG. 3 is a candlestick diagram showing a method for determining the position of a portable device (client) which communicates with a network which includes base stations. In the embodiment shown in FIG. 3 no server is required since each client stores a list with its own position information, i.e. a partial list.

Just as in FIG. 2, the client first broadcasts a discovery message in order to search the area for base stations and acquire base station identities (step 2.1). Each base station within transmission range then responds to the discovery message by broadcasting an announcement packet (steps 2.2 and 2.3). Also in this embodiment, the client may alternatively search the area and acquire base station identities by listening for announcement packets repeatedly broadcasted by the base stations.

When the client has received an announcement packet from at least one base station, it connects to that base station (base station 102) by requesting a connection with it (step 2.4). The base station then acknowledges the connection (step 2.5) and a link is established.

Thereafter, the client multicasts a discovery message for a required positioning service (step 2.6). In this embodiment, the list is stored as partial lists at each base station. Hence, each base station which receives the discovery message and provides the requested positioning service then responds with a service response message (steps 2.7 and 2.8).

When the client has received the service response message from each base station, the client requests for a partial list including position information from each base station via base station 102 (steps 2.9 and 2.11). Each base station, storing a partial list, then responds the client by transmitting the partial list to the client via base station 102 (steps 2.10 and 2.12).

When the client has received the partial lists including position information from the base stations, it disconnects from base station 102 (steps 2.13 and 2.14), and may now determine its own position from the partial lists with position information and the acquired base station identities (step 2.15).

The client may now go ahead updating the positioning by searching the area for new base stations (steps 2.16, 2.17 and 2.18), and again determine its own position (step 2.19).

The list with position information need only to be updated if for example the client enters an area with base stations not comprised in the list, or the position of a base station is changed.

Some examples of how the client may determine its position from the position information in the list and the acquired identities are given below.

The base station identities are first matched against the list in order to extract the positions of the base stations which are within transmission range from the client.

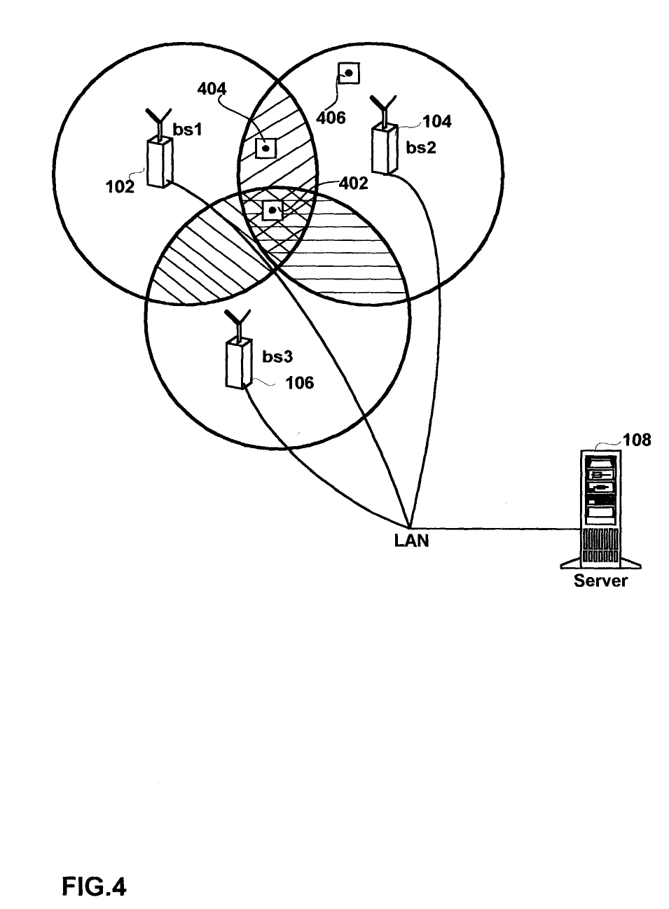

FIG. 4 schematically illustrates an embodiment of a system according to the invention in which the transmission ranges of three base stations are at substantially equal to one another. In FIG. 4, the base stations 102, 104 and 106 are assumed to have the same coverage as shown by the circles each around a corresponding one of the base stations. In this case, a client may calculate its position by simply taking the average of the positions of all base stations being within transmission range as shown in the following Formula 1.

$${X}_{Client} = \frac{Sum ( {X}_{bs1 ,} {X}_{bs2 ,} {X}_{bs3 ,} … {X}_{bsN ,} )}{N}$$

Each position value may comprise two or three coordinates depending on whether the position should be two or three dimensional.

In FIG. 4, client 402 is located in an area covered by base stations 102, 104 and 106. Using Formula 1, it will be able to determine the position of Client 402 with a high precision.

Client 404 is located in an area covered by base stations 102 and 104, but not by 106. Using Formula 1 above, it may also achieve a quite high positioning precision, but not so high as the case with client 402.

Client 406 is located in an area covered by only one of the base stations, i.e. base station 104. If client 406 only uses the formula above, it will not be able to determine its position by higher precision than having the same position as base station 104.

In order to achieve more accurate position determination in areas only covered by one (or two) base stations, a client may also use information, extracted from the list, about which base stations that are not within transmission range.

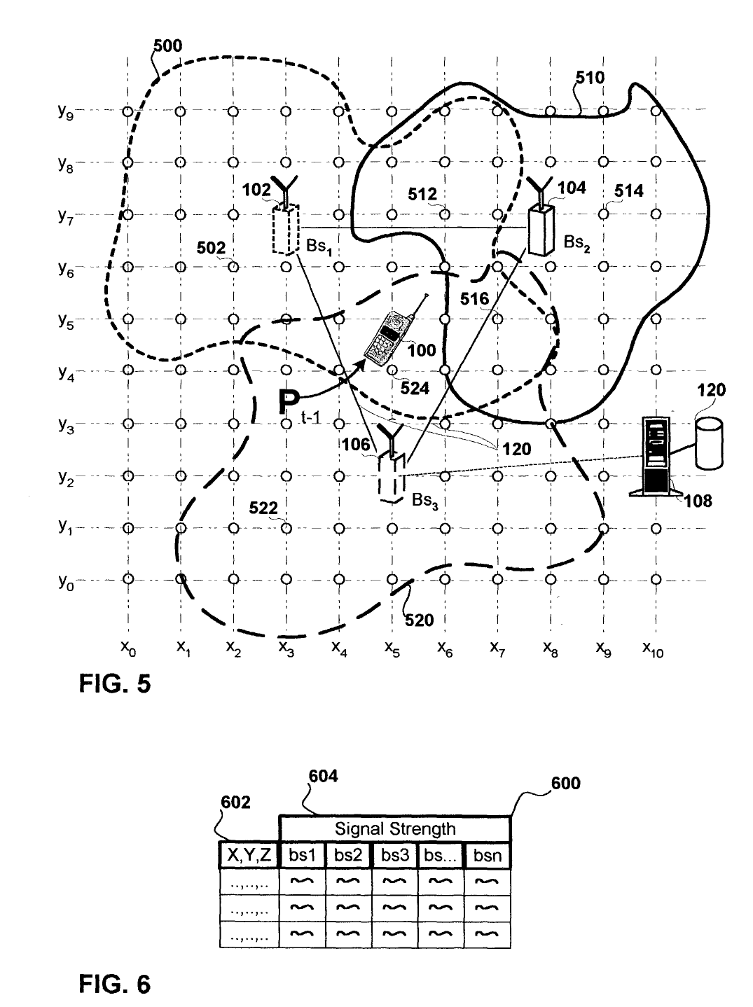

FIG. 5 schematically illustrates an embodiment of a system according to the invention in which the transmission ranges of three base stations are irregular and different. The three base stations 102, 104, 106 form a wireless communication network the coverage area of which is defined by the areas covered by the base stations are represented by the asymmetrical lines 500, 510, 520 of constant signal strength surrounding base stations 102, 104, 106 respectively. The base stations are superimposed on a common coordinate system. In the example shown in FIG. 5, a Cartesian coordinate system is shown. In alternate embodiments of the invention other coordinate systems, e.g. polar may be utilized. The coordinate system segments the areas covered by each base stations into a plurality of segments, e.g. squares or cubes depending on whether the position should be two or three dimensional. For each segment a determination is made at the time of deploying the base station network as to which stations cover each segment and what their respective signal strengths are within each segment. Alternately the determination made at time of deployment may involve a measurement of the received signal strength of at each base station from each segment in the coordinate system. Various segments 502, 512-516, and 522-524 in the Cartesian coordinate system are shown. The lists which correlate each segment with a transmitted and/or received signal strength at each base station is then stored in base station specific lists or in an aggregate list somewhere on the network, e.g. client(s), base station(s), or server(s), and do not have to change as long as the stationary network is unmodified. Using these lists, the position of each client within the coordinate system can be determined by correlating either the received signal strength from each base station at a client or the received signal strength from each client at each base station with the corresponding measured signal strengths in the list to determine which segment(s) the client is located in at any point in time.

In an embodiment of the invention a client may use information as to which among a set of segments includes signals from base stations the client is not receiving. These segments may then be excluded thereby reducing the number of possible segments in which the client may be located, and thereby increasing the accuracy of the positioning determination.

In an embodiment of the invention the clients past location Pₜ₋₁ in the coordinate system may be used to reduce the number of possible segments in which the client may be located. Segments proximate to the client's prior location will be more likely candidates for the client's current location.

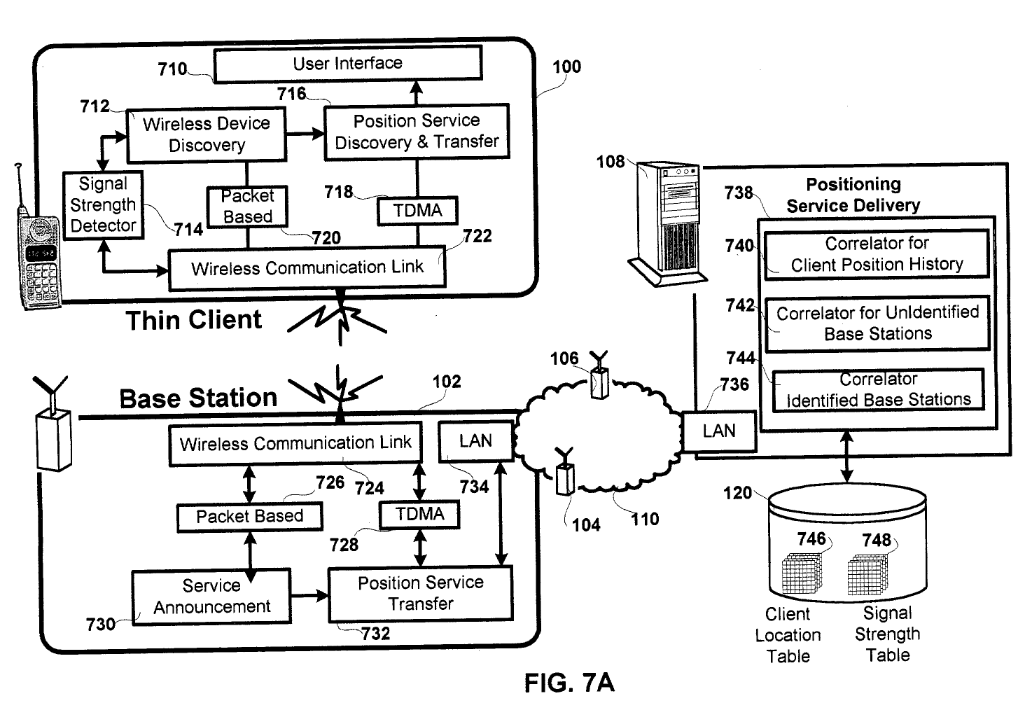

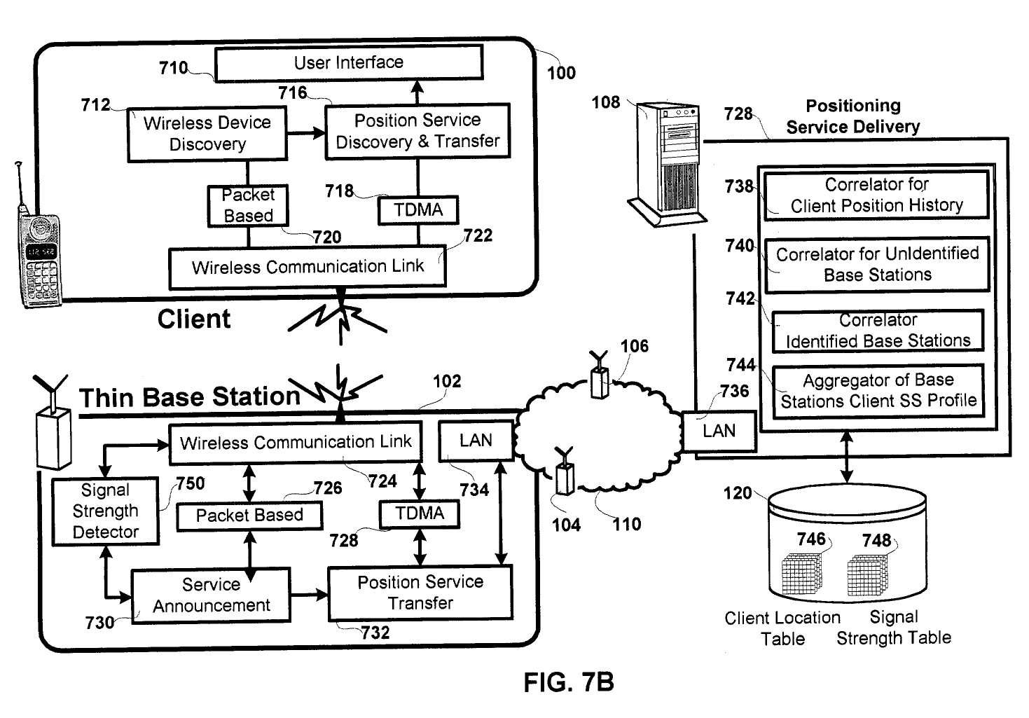

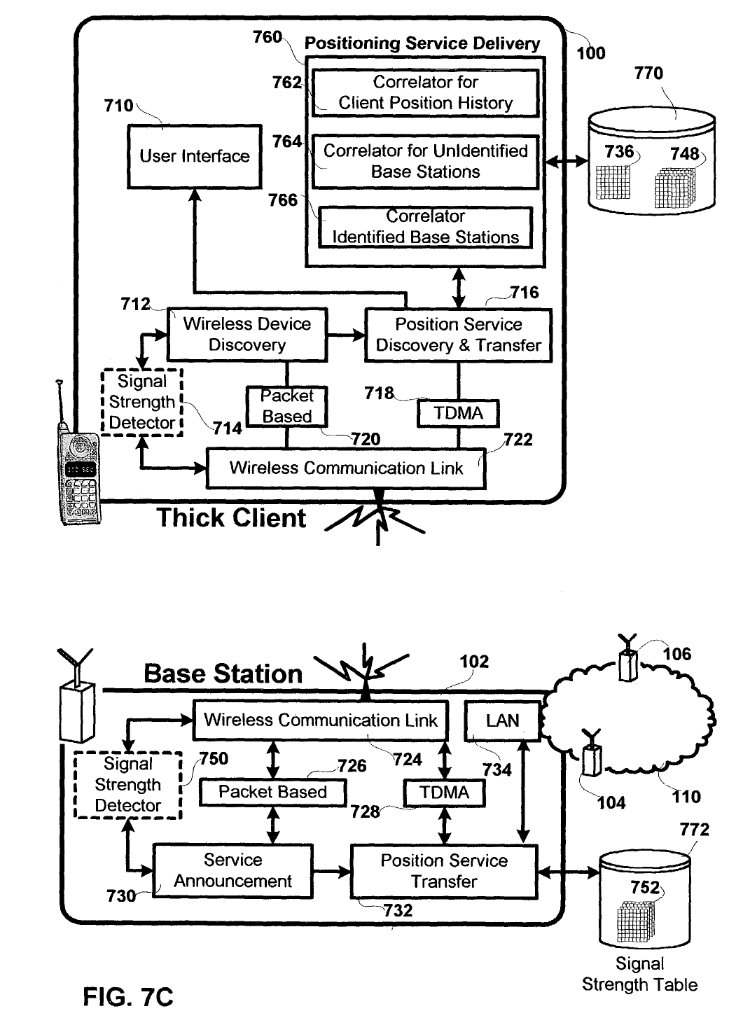

FIG. 6 is a data structure diagram of an embodiment of the position information for each base station. The signal strength table 600 characterizes signal strengths relative to each of plurality base stations at each of a plurality of locations in the wireless communication network. The positioning service module which may be part of the client, the base station or the server (See FIGS. 7A-C) correlates an actual received signal strength for a communication with the wireless device with at least one of the received signal strengths in the signal strength table, to determine the position of the wireless device.

The signal strength table 600 includes a record for each segment, with each record corresponding in the example shown to each row of the table. Each record contains the coordinates 602 of the segment, and either or both the transmitted or received signal strengths for each segment with respect to each base station 604. Signal strength data may be recorded in varying degrees of precision from a single binary bit to multiple bits of precision. The table may be stored as a single aggregate table with signal strengths for all the segments and all the base stations. This aggregate table can be stored on a server, a base station or a client. Alternately the signal strength information may be stored in a set of individual tables each recording for a single base station the transmitted or received signal strength for each segment.

FIGS. 7A-C are software block diagrams showing three different embodiments of the invention with varying position processing capabilities in one or more of the clients, base stations, and servers.

FIG. 7A shows software block diagrams for a thin client 100, base station 102 and server 108. The thin client 100 has a wireless communication link with base stations 102-106. Base stations 102-106 are coupled to one another and the server over network 110. The server 108 couples to storage 120. In this embodiment of the invention the client handles the determination of received signal strengths from each of the base stations 102-106 and the server handles the determination of the client's location using the signal strength table.

In an embodiment of the invention, the thin client 100 includes both an in band communication channel and an out of band communication channel for control and/or discovery. The former supports time-division communications with a plurality of base stations, and the latter supports station discovery and control signals. The in and out of band communication channels couple to a wireless communication link 722 which handles the wireless receipt and transmission of wireless communications. The out of band channel also includes: a packet module 720 for handling packet based communication, a wireless discovery module 712 for responding to initial communications from or initiating discovery of base stations, and a signal strength detector 714 for determining during initial communications with neighbouring base stations the IDs and received signal strengths of each base station within range. The in band channel includes: a time division multiple access (TDMA) module 718 for handling time division communication, a positioning service discovery and transfer module 716 and a user interface 710. The positioning service discovery and transfer module handles discovery of which base station(s) offer a positioning service, and handles the transfers connected with that service. After determining that positioning service is available, this module handles transfer to a selected base station of the client ID and the IDs and signal strengths of the base stations obtained by the signal strength detector 714. The base station handles the passing of this signal strength information to the server 108 and the return to the client of the position determined by the server. The client displays this information to the user via the user interface module 710. This module may include: audio, visual and or tactile presentation capabilities.

The base station 102 is shown in detail. This base station includes: a wireless communication link 724 for communicating with clients and a network communication link 734 for communication with other base stations 104-106 and the server 108. The wireless communication link includes an in band and an out of band communication channel. The former supports time-division communications with a plurality of clients, and the latter supports client discovery and control signals. The in and out of band communication channels couple to the wireless communication link 724 which handles the wireless receipt and transmission of wireless communications. The out of band channel also includes: a packet module 726 for handling packet based communication, a service announcement module 730 for responding to initial communications from a client as to service(s) available from the base station. The in band channel includes: a time division multiple access (TDMA) module 728 for handling time division communication, and a positioning service and transfer module 732. The positioning service and transfer module handles transfers to and from the client in connection with the positioning service offered by the base station. After a client has identified the base station as providing a positioning service this module handles receipt from a client of the client ID and the IDs and signal strengths of the base stations obtained by the client. This module interfaces with the LAN module 734 to pass this signal strength information to the server 108 and to return to the client the position determined by the server. The server 108 is shown in detail. The server includes: a local area network (LAN) module for interfacing with network and a positioning service module 738 for making the position determination for each client requesting same. The positioning service module interfaces with memory 120 in which are stored the signal strength table(s) 748 and also optionally one or more client location tables 746. The signal strength tables contain the signal strength information for each base station in each segment of the coordinate system in which the base stations 102-106 have coverage as shown and discussed above in connection with FIG. 6 and as determined at time of deployment. In an embodiment of the invention memory 120 may also include a client location table in which the positioning service module 738 and specifically sub-module 740 thereof stores prior client locations as determined during prior client location requests. This information is used in an embodiment of the invention to narrow down possible locations of a client to those locations proximate to a prior location. The positioning service module includes: an identified base station correlator 744, and may also have either or both of a correlator for unidentified base stations 742 and a correlator for client position history 740. The correlator of identified base stations correlates the received signal strengths from each base station obtained from a requesting client with the segment specific signal strengths from each base station obtained at time of deployment and stored in the signal strength table 748. This correlation results in the identification of one or more segments each with a corresponding location in which the client is determined to be located. In an embodiment of the invention this location information is passed to the client without further processing.

In an alternate embodiment of the invention module 742 provides an additional level of correlation which may increase the accuracy with which the location of the client is determined. The unidentified base station correlator 742 uses the negative information as to which base stations the client has not identified in the signal strength information received by the server to improve the accuracy of the client location determination. This negative information is correlated with the set of qualifying segments identified by sub-module 744 to remove from the set those segments which are listed in the signal strength table 748 as having a receivable signal strength from one or more base stations which the client has not identified.

In an alternate embodiment of the invention module 740 provides an additional level of correlation which may increase the accuracy with which the location of the client is determined by either or both of sub-modules 742-744. The client position history correlator 740 uses stored client position information each time a determination of same is made and then uses that information when a new location request is being processed to improve the accuracy of the client location determination. In an embodiment of the invention this location history information is correlated with the set of qualifying segments identified by sub-modules 742-744 to retain in the set those segments proximate to the clients previous position as identified in the client location table 746. In alternate embodiments of the invention the client history including at least two prior locations may be used by the correlator 740 to identify a path vector for the client. The path vector is correlated with the set of qualifying segments identified by sub-modules 742-744 to retain in the set those segments with positions proximate to an extension of the client vector. In still another embodiment of the invention the client history including at least two prior locations and the associated times at which the client was identified at each location may be used by the correlator 740 to identify a path vector and speed for the client. The path vector is correlated with the set of qualifying segments identified by sub-modules 742-744 to retain in the set those segments with positions proximate to an extension of the client vector the magnitude of which corresponds with the clients speed.

In an alternate embodiment of the invention the server 108 may be physically incorporated into and integral with one of the base stations.

FIG. 7B shows an alternate embodiment of the invention to that shown in FIG. 7A. In this embodiment of the invention the base stations 102-106 handle the determination of received signal strengths from a client and this information is passed to the server 108 which handles the determination of the client's location using the signal strength table which in this case includes the received signal strength at each base station from transmissions originating in each segment of the coordinate system as determined at time of deployment. Software block diagrams for the client 100, base station 102 and server 108 are shown. The client 100 has a wireless communication link with base stations 102-106. Base stations 102-106 are coupled to one another and the server over network 110. The server 108 couples to storage 120.

The client operates as discussed above in connection with FIG. 7A with the exception that the client makes no signal strength determination, this capability residing in the base stations instead. In this embodiment of the invention the client discovers a location service provided by one of the base stations and receives from the base station the identified segment(s) in which the server has determined the client is located. The client then delivers this information to the user through the user interface 710.

The base station 102 is shown in detail. The base station operates as discussed above in connection with FIG. 7A with the exception that the base station includes a signal strength detector 750. This signal strength detector is used by the base station to determine received signal strength from each client in the net. This information is passed to the server from each base station and used to build a complete set of client identification information including the received signal strengths of the client at one or more base stations. The server correlates this information with the information in the signal strength table which in this case includes the received signal strength at each base station from transmissions originating in each segment of the coordinate system as determined at time of deployment. In an embodiment of the invention the client makes a positioning service request subsequent to which the base station communicates the request to other base stations in the network all of which then determine the clients signal strength and pass it to the server. In another embodiment of the invention the base stations continuously monitor signal strength of all clients in the network and deliver it to the server. When a client makes a position request the server already has the information required to make the position determination.

The server 108 is shown in detail. The server operates as discussed above in connection with FIG. 7A with the exception that the server includes an aggregator module 744. The aggregator module takes the information from each base station on either a push or a pull basis as to the received signal strength of each client and aggregates this information to obtain a complete picture of the received signal strength at one or more base stations from a requesting client. The server correlates this information with the information in the signal strength table which in this case includes the received signal strength at each base station from transmissions originating in each segment of the coordinate system as determined at time of deployment.

In an alternate embodiment of the invention the server 108 may be physically incorporated into and integral with one of the base stations.

FIG. 7C shows an alternate embodiment of the invention to that shown in FIG. 7A. In this embodiment of the invention the client contains much of the position determination capability formerly associated with the server therefore eliminating the need for a server. The base stations contain, in either individual or aggregate form, the signal strength table for all base stations in the network. The actual values in the signal strength tables may be for either or both: the received signal strength at each segment in the coordinate system for transmissions from each base station or the received signal strengths at each base station from transmissions originating in each segment of the coordinate system. The client correlates actual signal strength information determined either by itself or by the base station(s) with the signal strengths measured at time of deployment in the signal strength tables. Based on the correlation the client is able to determine its own position.

The base station 102 is shown in detail. The base station operates as discussed above in connection with FIG. 7B with two exceptions. First, there is no server and each base station contains in memory 772, in either individual or aggregate form, the signal strength table 752 for all base stations in the network obtained at time of deployment. Where each base station contains only its own individual signal strength table the base station responds to a client location request by obtaining additional signal strength tables from the other base stations to which it is coupled on the LAN or other network and passes these to the requesting client. Where each base station contains signal strength tables 752 for the entire network these are passed to the requesting client. Second, the base station in one embodiment of the invention does and in another does not include the signal strength detector 750. Where the base station includes a signal strength detector, the base station passes received signal strength information to the client for processing along with all or an associated part of the signal strength table. Where the base station does not include a signal strength detector, the base station passes to the client all or an associated part of the signal strength table only, since the client in this embodiment determines signal strength itself

The client 100 has packet and TDM based communication paths as discussed above in connection with FIG. 7A. Additionally the client has the additional processing capability formerly associated with the server. Specifically the client includes the positioning service delivery module 760. This module contains one or more of the following sub-modules for determining the clients position: the correlator 766 for identified base stations; the correlator 764 for unidentified base stations; and the correlator for client position history 762. The client includes an attached memory 770 to which the positioning service module 760 is coupled. This memory contains at least a copy of the signal strength table(s) obtained from the base stations and may additionally contain a client history table 736.

After the client or base station has determined the actual signal strength, the client downloads the signal strength table(s) from the base station. The signal strength tables and the actual signal strength are then passed to the position service module 760. The position service module then correlates this information with the information in the signal strength table. The correlator 766 of identified base stations performs the same function as the server side identified base station correlator 744 discussed above in connection with FIG. 7A, i.e. correlating the transmitted or received signal strengths with the segment specific signal strengths of each base station obtained at time of deployment and stored in the signal strength table. The unidentified base station correlator 764 performs the same function as the server side correlator 742 discussed above in connection with FIG. 7A. This sub-module correlates negative information as to base stations not detected by the client (client side signal strength detector embodiment) or as to base stations not detecting the client (base station side signal strength detector embodiment) with the set of qualifying segments identified by sub-module 766 to remove from the set those segments which are listed in the signal strength table 748 as having a receivable signal strength at the corresponding one of the base station or the client. In still another embodiment of the invention the client position history sub-module 762 serves a similar function as the server side client position history sub-module 740 discussed above in FIG. 7A. This module uses client position, and or direction and speed information to reduce the possible client locations identified in either or both of sub-modules 764-766. After a position determination is made by the positioning service module, the information is passed to the user via user interface 710.

The embodiment of the invention shown in FIGS. 7A-C makes it possible to achieve more accurate positioning in less time, by only having to establish one single full connection with one single base station in order to get information about the positions of other base stations presently being within transmission range from the device. This single connection is established in order to receive a list comprising information about the positions of two or more base stations. The information about which base stations are within transmission range from the device is obtained by said acquisition of the identities of one or more base stations, and this acquisition of identities is made without establishing a full connection with any base station. A portable device may instead acquire the identities during searching of the environment for base stations. This search may in some embodiments comprise listening for announcement packets repeatedly broadcasted by the base stations. In some other embodiments, the search may comprise broadcasting of a discovery packet requiring all base stations to respond. In both cases, the identity is included in the packets sent by the base stations. The thus acquired base station identities may be matched against the retrieved list with base station positions and the result of the matching may then be used to calculate a more accurate value of the position of the portable device. With the present invention, it is possible to accomplish relatively fast and easy updating of a list comprising information about the positions of several base stations. For example, each time a person with a portable device enters a new area with base stations not included in a list that has been previously downloaded to the device, the previous list may easily be updated or even replaced by downloading a new list from a nearby base station. Also if the position of a base station is changed by some reason, the list may need to be updated. Within the scope of the present invention, it is possible to optimise the total time for downloading lists while moving around within an area of base stations. If the time for downloading one list is to be minimized, the list may include only a few nearby base stations so that it may be made small. On the other hand, if the number of downloads is to be minimized, the list may include all base stations in a local area network or even all base stations in a wide area network. A high personal integrity may be obtained in the embodiment of the invention shown in FIG. 7C since the determination of the position of a portable device is made by the device itself, without base stations or connected servers doing any part of the determination. This embodiment of the invention provides possibility for fast updating of the positioning during movement within an area with base stations, since the updating may be provided simply by acquiring new identities, which, as defined, not requires full connection establishment. The thus acquired identities may then be matched against a list already downloaded to the device. If, for example, a person with a portable device enters a large building with an internal network of base stations, he would only have to download the list of positions once after a first reception of a base station identity, where after updating of which base stations that are presently within transmission range during movement is carried out by the search for new identities.

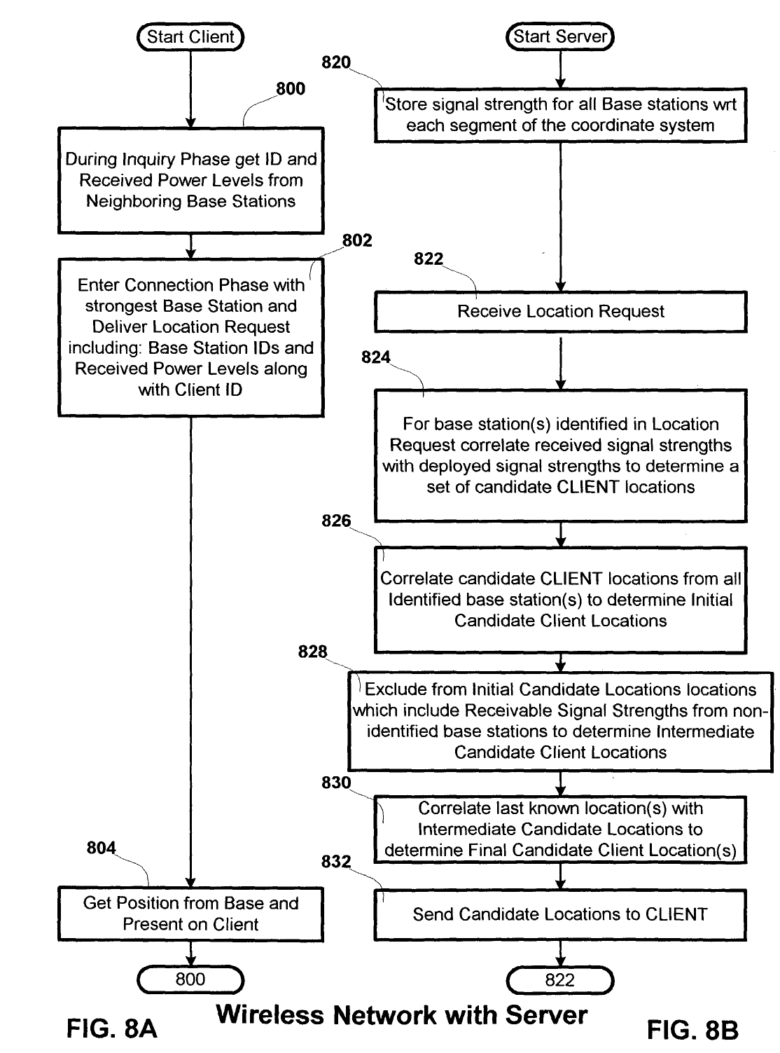

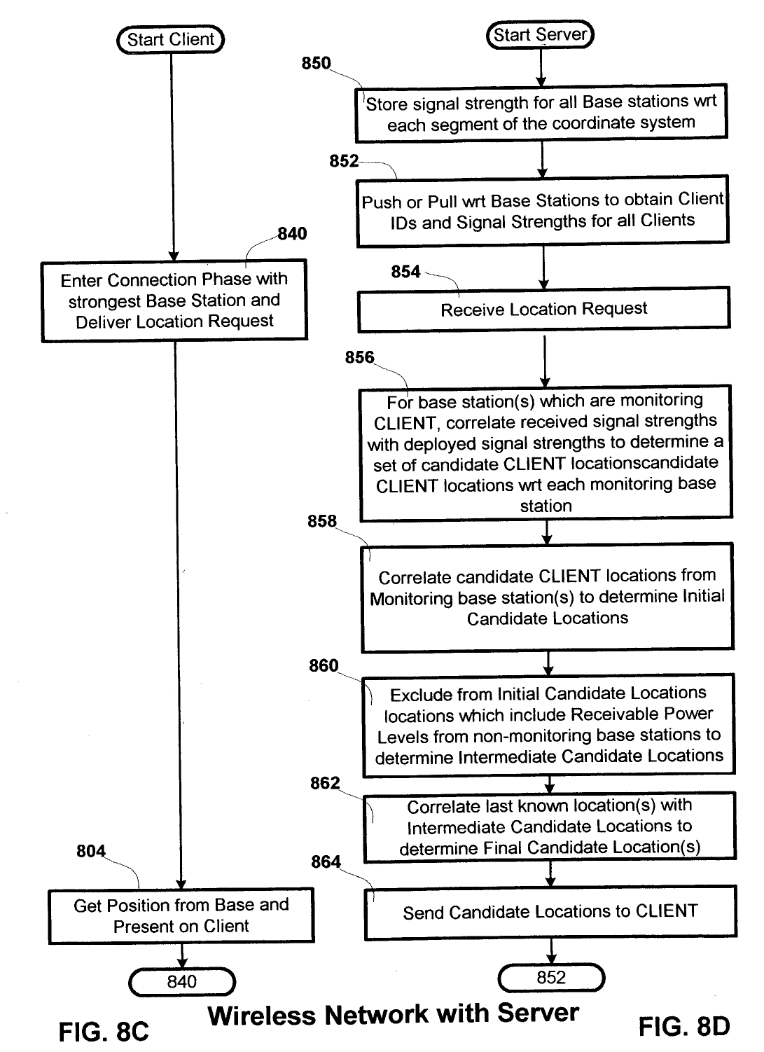

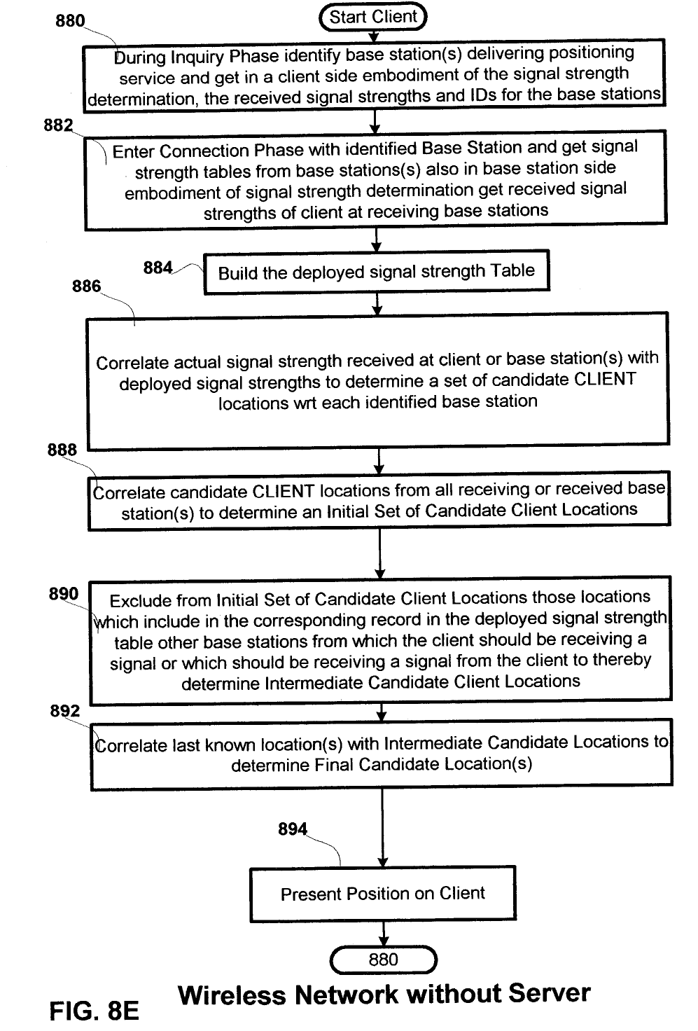

FIGS. 8A-E are process flow diagrams associated with position determination in the embodiments of the invention shown in FIGS. 7A-C.

The process flow shown in FIGS. 8A-B correspond with the embodiments of the invention shown in FIG. 7A for the client and server respectively.

Client side processing as shown in FIG. 8A includes processes 800, 802, 804 and server side processing includes processes 820-832. Processing begins on the client with process 800 in which during an inquiry phase of communications the client determines the actual signal strengths of communications from one or more of the base stations. In the subsequent process 802 this information is passed in a connection phase of operation over a TDMA channel to the base station which the client has identified as offering the position determination service. The base station forwards this information to the server. Subsequent to a determination by the server the position information is passed from the server via the base station back to the client in process 804 and is displayed by the client.

On the server side as shown in FIG. 8B processing begins in process 820. In process 820 the signal strengths from each base station at each segment of the coordinate system are stored on the server. Next, in process 822 a client position/location request is received by the server along with the associated actual signal strengths and associated base station identifiers determined by the requesting client. In processes 824-826 for base station(s) identified in the location request the received signal strengths of each base station at the requesting client is correlated with the deployed signal strengths in the signal strength table to determine a set of initial candidate client locations in the coordinate system. Correlation as discussed above may be done simply by matching a received signal strength and base station ID with one or more corresponding records in the signal strength table and retaining only those records for which a match exists for all the identified base stations. Alternately probabilities may be assigned to all locations based on the extent of match in signal strength and the number of identified base stations for which the match exists. In the first embodiment the initial client location set comprises those locations for which there is an exact match in signal strength for all identified base stations. In the alternate embodiment the initial client location set comprises those locations with the highest combined probability score for actual vs. deployed signal strength for all identified base stations. Processes 828 and 830 are optional and either or both may be used to improve the precision of client location determination. In process 828 locations are excluded from the initial set of candidate client locations for which the corresponding record in the deployed signal strength table indicates a receivable signal strength from a base station and yet are not identified in the client location request. As to these locations the deployed signal strength record indicates the un-identified base station should have been identifiable and therefore the fact that it was not indicates that the particular segment of the set is probably not one where the client is located. This elimination may be performed by rejection or by a lowering of the probability assigned to the location. In either case an intermediate set of candidate client locations results. Next in process 830 the intermediate set of candidate locations is further correlated in this case by correlating the last known client location with the intermediate set of client locations. Where only prior client position is known the final candidate client location set includes members of the intermediate set proximate to the client's prior location. Where the client's prior positions at more than one location are known the clients path or direction can be determined. In this embodiment then the final candidate client location set includes members of the intermediate set on an extension of the client's known path vector. Where both the client's prior positions and time of positioning are known the speed and direction of the client can be determined and in this instance the final set of candidate client locations includes members of the intermediate set on an extension of the client's known path vector, where the extension has an associated scalar which corresponds with the client's speed of movement. Finally, in process 832 the final set of candidate location(s) is sent to the client for presentment to the user or for use in some process or application performed on the client.

FIGS. 8C-D show the processes associated with the client and the base station and server side processing in the embodiment of the invention shown in FIG. 7B. Processing on the client side as shown in FIG. 8C begins in process 840 with the delivery from the client to the selected base station which delivers the positioning service of the client location request. Next in process 804 the position determined by the server for the client is delivered to the client via the base station.

On the server and base station side as shown in FIG. 8D processing begins in process 850. In process 850 the signal strengths at each base station from each segment of the coordinate system are stored on the server. Next in process 852 the actual signal strengths of transmissions from the client are delivered to the server. In an embodiment the base station receiving a client location request notifies other base stations on the network to monitor the requesting client and to forward their individual determinations of the clients received signal strength to the server. In an alternate embodiment of the invention the server continuously requests determinations of client signal strength from each of the base stations. Next in process 854 a client position/location request is received by the server. In processes 856-858 for base station(s) identified in the location request the received signal strengths at each base station from the requesting client are correlated with the deployed signal strengths in the signal strength table to determine a set of initial candidate client locations in the coordinate system. Correlation as discussed above may be done simply by matching a received signal strength and base station ID with one or more corresponding records in the signal strength table and retaining only those records for which a match exists for all the identified base stations. Alternately probabilities may be assigned to all locations based on the extent of match in signal strength and the number of identified base stations for which the match exists.

The subsequent processes 860 and 862 are optional and either or both may be used to improve the precision of initial candidate client locations. In process 860 locations are excluded from the initial set of candidate client locations for which the corresponding record in the deployed signal strength table indicates a receivable signal strength from the client at one or more base stations other than those actually reporting a signal from the client. As to these locations the deployed signal strength record indicates that one or more monitoring base station should have been able to monitor the client and therefore the fact that they were not able to indicates that the particular segment of the set is probably not one where the client is located. This elimination may be performed by rejection or by a lowering of the probability assigned to the location. In either case an intermediate set of candidate client locations results. Next in process 862 the intermediate set of candidate client locations is further correlated in this case by correlating the last known client location, with the intermediate set of client locations. Where only prior client position is known the final candidate client location set includes members of the intermediate set proximate to the client's prior location. Where the client's prior positions at more than one location are known the clients path or direction can be determined. In this embodiment then the final candidate client location set includes members of the intermediate set on an extension of the client's known path vector. Where both the client's prior positions and time of positioning are known, the speed and direction of the client can be determined and in this instance the final set of candidate client locations includes members of the intermediate set on an extension of the client's known path vector, where the extension has an associated scalar which corresponds with the client's speed of movement. Finally, in process 864 the final set of candidate location(s) is sent to the client for presentment to the user or for use in some process or application performed on the client.

FIG. 8E shows the processes associated with the client and the base station processing in the embodiment of the invention shown in FIG. 7C. Processing begins in process 880 in which the client identifies base stations delivering the positioning service. That service may include delivery of the deployed signal strength table alone or in combination with received signal strengths of the client at one or more of the base stations. Alternately, the client may include signal strength determination capability, in which event actual signal strengths are determined at this time by the client for all receivable base stations. Next in process 882 the client retrieves the signal strength tables from the base station. Where the base stations include signal strength determination capability the client will also receive at this time the received signal strengths of the client at one or more of the base stations.

In process 884 the deployed signal strengths received from the base station are stored by the client. Next in processes 886-888 the actual signal strengths of transmissions from the client to the base station or vice versa are correlated with the deployed signal strengths in the signal strength table built by the client to determine a set of initial candidate client locations in the coordinate system. Correlation may be done using simple matching of received signal strengths with each record in the signal strength table or by the assignment of probabilities to all records as discussed above.

The subsequent processes 890 and 892 are optional and either or both may be used to improve the precision of initial candidate client locations. In process 890 locations are excluded from the initial set of candidate client locations for which the corresponding record in the deployed signal strength table includes other base stations from which the client should be receiving a signal or which should be receiving a signal from the client to thereby determine an intermediate set candidate client locations. Next in process 892, the intermediate set of candidate client locations is further correlated with the last known client location, or path, or path and speed to determine final set of candidate client locations. Finally, in process 894 the final set of candidate location(s) is presented by the client either directly to the user or indirectly to a process or application performed on the client.

The foregoing description of preferred embodiments of the invention has been presented for purposes of illustration and description. It is not intended to be exhaustive or to limit the invention to the precise forms disclosed. Obviously many modifications and variations will be apparent to practitioners skilled in this art. It is intended that the scope of the invention be defined by the following claims and their equivalents.

What is claimed is:

1. An apparatus for determining a location of a wireless device in a wireless communication network provided by a plurality of base stations; and the apparatus comprising:
a signal strength table characterizing signal strengths relative to each of plurality base stations at each of a plurality of locations in the wireless communication network; and
a positioning service module to correlate an actual received signal strength for a communication with the wireless device with at least one of the received signal strengths in the signal strength table, whereby to determine the position of the wireless device.

2. The apparatus of claim 1, wherein the signal strength table further characterizes at least one of a received signal strength for transmissions from each of the plurality of base stations to each of the plurality of locations; and a received signal strength at each of the base stations for transmissions from the wireless device positioned at each of the plurality of locations.

3. The apparatus of claim 1, wherein the positioning service module further configured to correlate the actual received signal strength at each of the base stations for a transmission from the wireless device with the signal strengths characterized in the signal strength table, whereby to determine a position of the wireless device.

4. The apparatus of claim 1, wherein the positioning service module further configured to correlate the actual received signal strength at the wireless device for transmissions from each of the base stations with the signal strengths characterized in the signal strength table, whereby to determine a position of the wireless device.

5. The apparatus of claim 1, further comprising:
a server coupled to the plurality of base stations and including the signal strength table and the positioning service module, and the server determining the location of the wireless device.

6. The apparatus of claim 5, wherein a selected one of the base stations includes the server integral therewith.

7. The apparatus of claim 1, wherein the wireless device includes the positioning service module and the base stations include the signal strength table and deliver same to the wireless device responsive to a positioning request from the wireless device.

8. A method for determining a location of a wireless device in a wireless communication network provided by a plurality of base stations; and the method comprising:
characterizing signal strengths relative to each of the base stations at each of a plurality of locations in the wireless communication network; and
correlating an actual received signal strength for a communication with the wireless device with at least one of the signal strengths characterized in the characterizing act, whereby to determine the position of the wireless device.

9. The method for characterizing of claim 8, wherein the characterizing act further comprises at least one of the acts of:
characterizing a received signal strength for transmissions from each of the plurality of base stations to each of the plurality of locations; and
characterizing a received signal strength at each of the base stations for transmissions from the wireless device positioned at each of the plurality of locations.

10. The method for correlating of claim 8, wherein the correlating act further comprises at least one of the acts of:
correlating the actual received signal strength at each of the base stations for a transmission from the wireless device with the signal strengths characterized in the characterizing act, whereby to determine a position of the wireless device; and
correlating the actual received signal strength at the wireless device for transmissions from each of the base stations with the signal strengths characterized in the characterizing act, whereby to determine a position of the wireless device.

11. A method in a portable device for determining a position of the portable device in a wireless communication network provided by a plurality of base stations; and the method comprising:
acquiring an identity of at least one of the plurality of base stations within a transmission range of the portable device,
retrieving a list comprising information about which of the plurality of base stations cover specific position segments in the wireless communication network formed by the plurality of base stations; and
determining the position of the portable device from the information in the list and the acquired identity.

12. The method of claim 11, wherein the list further comprises: information about possible position segments in which the portable device may be located for a given combination of acquired base station identities.

13. The method of claim 11, wherein the plurality of base stations are wireless access points connected to one another in a common network.

14. The method of claim 11, wherein the list includes both information about the position of at least one of the plurality of base stations out of a transmission range of the device together with information about the position of at least one of the plurality of base stations within the transmission range of the device.

15. The method of claim 11, wherein the acquiring act further comprises:
listening for announcement packets broadcasted by the at least one of the plurality of base stations, wherein each announcement packet includes the identity of the corresponding base station.

16. The method of claim 11, wherein the acquiring act further comprises:
broadcasting a discovery packet requiring a response from each of the plurality of base stations within a communication range of the portable device; and
receiving a response packet from corresponding ones of the plurality of base stations within the communication range of the portable device, wherein each said response packet comprises the identity of the corresponding base station.

17. A portable device operable in a wireless communication network provided by a plurality of base stations; and the portable device comprising:
means for acquiring an identity of at least one of the plurality of base stations within a transmission range of the portable device;
means for retrieving a list comprising information about which base stations cover specific position segments in the wireless communication network formed by the plurality of base stations; and
means for determining the position of the portable device from the information in the list and the acquired identity.

18. The portable device of claim 17, wherein the list includes both information about the position of at least one of the plurality of base stations out of a transmission range of the device together with information about the position of at least one of the plurality of base stations within the transmission range of the device.

19. The portable device of claim 18, wherein the means for determining the position of the device further comprises:
means for using information about the position of the at least one of the plurality of base stations out of the transmission range of the portable device in addition to the information about the position of the at least one of the plurality of base stations within the transmission range of the portable device to determine the position of the portable device.

20. The portable device of claim 17, wherein the list further comprises:
information about possible position segments in which the portable device may be located for a given combination of acquired base station identities.

21. A method for determining a position of a portable device in a wireless communication network provided by a plurality of base stations; and the method comprising:
transmitting an identity from corresponding ones of the plurality of base stations within a transmission range of the portable device to the portable device;
transmitting a list from one of the plurality of base stations to the portable device, and the list comprising information about which of the plurality of base stations cover specific position segments in the wireless communication network formed by the plurality of base stations; and
determining within the portable device, a position of the portable device from the information in the list and the transmitted identity.

22. The method of claim 21, wherein the retrieving act further comprising the acts of:
coupling a server containing the list to the plurality of base stations; and
retrieving the list from the server.

23. The method of claim 21, wherein the retrieving act further comprises the acts of:
storing specific portions of the list pertaining to each of the plurality of base stations at corresponding ones of the plurality of base stations; and
retrieving the specific portions of the list from each of the plurality of base stations.
